(19) United States
(12) Patent Application Publication
(10) Pub. No.: US 2015/0039511 A1
(43) Pub. Date: Feb. 5, 2015

(54) MOBILE COMPUTING DEVICE, A METHOD FOR PERFORMING A TRANSACTION, AND A COMPUTER-READABLE STORAGE MEDIUM

(71) Applicant: MASTERCARD ASIA PACIFIC PTE. LTD., Singapore (SG)

(72) Inventor: Ruben Salazar Genovez, Singapore (SG)

(73) Assignee: MASTERCARD ASIA PACIFIC PTE. LTD., Singapore (SG)

(21) Appl. No.: 14/448,390

(22) Filed: Jul. 31, 2014

(30) Foreign Application Priority Data
Aug. 2, 2013 (SG) 201305896-1

(51) Int. Cl. G06Q 20/32; G06Q 20/40

(52) U.S. Cl. CPC G06Q 20/322; G06Q 20/40
USPC 705/44; 705/39

(57) ABSTRACT

Various embodiments provide a mobile computing device comprising: a communication interface configured in use to wirelessly transmit and receive data; and a controller configured in use to cause the communication interface to transmit payment information to an external device to perform a transaction, the payment information including account information received by the communication interface from a server device, the account information specifying an account for use in performing the transaction.

### TECHNICAL FIELD

Various embodiments relate to a mobile computing device, a method for performing a transaction and a computer-readable storage medium. A specific embodiment relates to a mobile computing device for performing a transaction.

### BACKGROUND

It is known to provide a mobile computing device capable of performing a vast array of different operations. For example, a mobile computing device may be a mobile telephone or a tablet computer. A single mobile computing device may be used to: participate in a telephone call via a mobile telecommunications network, browse the internet via a Local Area Network, take photographs, play music, display and manipulate art, play games, and connect with social networks, to name but a few.

It is known to provide payment cards to facilitate the performing of transactions electronically. A customer may have one or more payment cards, such as, for example, one or more credit or debit cards. The customer may use one of the payment cards in conjunction with a merchant's device (e.g. an electronic point of sale) to perform a transaction with the merchant. For example, the customer may wish to purchase goods or services from the merchant, and so the customer may use the payment card to transfer funds or payment into the merchant's account in exchange for receiving the goods or services from the merchant. The payment card may be fitted with a Near Field Communications interface to enable the payment card to electronically communicate with the merchant's device to perform the transaction.

### SUMMARY

Various embodiments provide a mobile computing device comprising: a communication interface configured in use to wirelessly transmit and receive data; and a controller configured in use to cause the communication interface to transmit payment information to an external device to perform a transaction, the payment information including account information received by the communication interface from a server device, the account information specifying an account for use in performing the transaction.

In an embodiment, the payment information authorizes the external device to take payment from the account to perform the transaction.

In an embodiment, the payment information authorizes the external device to authorize a further external device to take payment from the account to perform the transaction.

In an embodiment, the payment information authorizes the external device to add payment to the account to perform the transaction.

In an embodiment, the mobile computing device further comprises an input interface configured in use to receive an input from a user of the mobile computing device.

In an embodiment, the controller is configured in use to cause the communication interface to transmit a request for the account information to the server device in dependence on the input.

In an embodiment, the controller is configured in use to cause the communication interface to transmit the payment information to the external device in dependence on the input.

In an embodiment, the mobile computing device further comprises a locking interface configured in use to receive an unlock instruction from the user, wherein the controller is configured in use to disable the mobile computing device based on a comparison between the unlock instruction and a valid unlock key.

In an embodiment, the communication interface is configured in use to receive the valid unlock key from the server device and to provide the valid unlock key to the controller to perform the comparison.

In an embodiment, the locking interface comprises a biometric sensor for sensing a value of a biometric identifier of the user and the unlock instruction includes the value of the biometric identifier, and wherein the valid unlock key includes a valid value of the biometric identifier.

In an embodiment, the controller is configured in use to disable the mobile computing device in response to receiving a locking instruction from the server device.

In an embodiment, the mobile computing device further comprises a location detector for detecting a location of the mobile computer device, wherein the controller is configured in use to cause the communication interface to transmit the location of the mobile computing device to the server device.

In an embodiment, the controller is configured in use to include the location of the mobile computing device in the payment information.

In an embodiment, the mobile computing device further comprises a display screen, wherein the controller is configured in use to cause the display screen to display information based on data received by the communication interface.

In an embodiment, the mobile computing device is housed within a case having the following dimensions: 0.085 m×0.054 m×0.007 m.

In an embodiment, the mobile computing device is a payment device.

Various embodiments provide a method for performing a transaction, the method comprising: receiving account information from a server device at a mobile computing device, the account information specifying an account for use in performing a transaction; and transmitting payment information from the mobile computing device to an external device to perform the transaction, the payment information including the account information.

Various embodiments provide a computer-readable storage medium having stored thereon computer program code which when executed by a computer causes the computer to execute the above-described method.

Various features of the above-described mobile computing device are applicable and are hereby restated in respect of the above-described method and computer-readable storage medium.

### BRIEF DESCRIPTION OF THE DRAWINGS

Embodiments of the invention will be better understood and readily apparent to one of ordinary skill in the art from the following written description, by way of example only, and in conjunction with the drawings, wherein like reference signs relate to like components, in which:

FIG. 1 is a schematic diagram of a mobile computing device in accordance with an embodiment;

FIG. 2 is a flow diagram of a method for performing a transaction using the mobile computing device of FIG. 1;

FIG. 3 is a schematic diagram of a mobile computing device in accordance with an embodiment;

FIGS. 4A to 4D illustrate an exemplary user interface for performing a transaction using a mobile computing device according to an embodiment; and

FIGS. 5A to 5D illustrate an exemplary user interface for performing a transaction using a mobile computing device according to an embodiment.

### DETAILED DESCRIPTION

Various embodiments relate to a mobile computing device, a method for performing a transaction, and a computer-readable storage medium. In an embodiment, a ‘transaction’ is taken to mean a financial transaction wherein a financial payment of money is exchanged for goods and/or services. ‘Performing’ a transaction may also be referred to as ‘completing’ a transaction or ‘transacting’.

Some portions of the description which follow are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “calculating”, “comparing”, “determining”, “generating”, “outputting”, or the like, refer to the action and processes of a computing device, or similar electronic device, that manipulates and transforms data represented as physical quantities within the computing device into other data similarly represented as physical quantities within the computing device or other information storage, transmission or display devices.

In addition, the present specification also implicitly discloses a computer program, in that it would be apparent to the person skilled in the art that the individual steps of the method and operation described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the scope of the appended claims.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer.

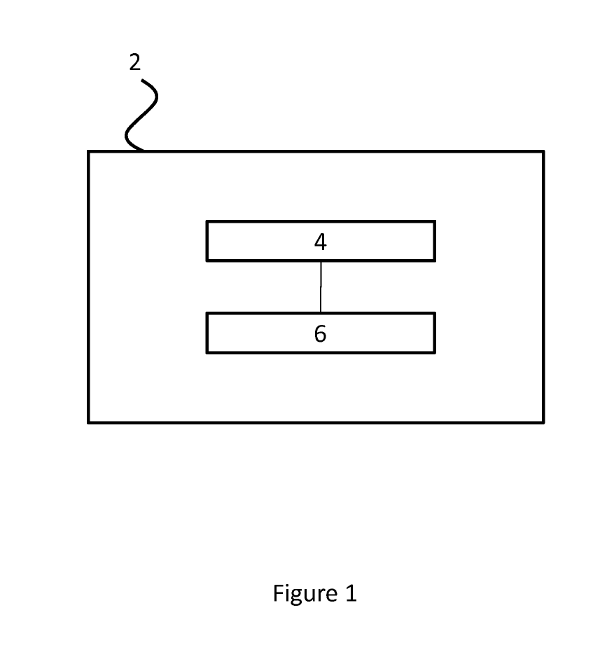

FIG. 1 represents a mobile computing device 2 in accordance with an embodiment. The mobile computing device 2 comprises a communication interface 4 in communication with a controller 6.

The communication interface 4 is configured in use to wirelessly transmit and receive data with, for example, external devices and server devices. The communication interface 4 may include one or more antennas and associated circuitry (not shown) for transmitting and receiving data at one or more different frequencies. The communication interface 4 may be configured in use to control the one or more antennas to transmit and receive data in accordance with one or more different communication standards and protocols. In this way, the communication interface 4 may access the Internet or other network systems such as a Local Area Network (LAN), a Wireless Personal Area Network (WPAN), a Wide Area Network (WAN) and/or the like. Additionally, the communication interface 4 may be configured to communicate via Wi-Fi, Bluetooth™, Near Field Communication (NFC), Global Positioning System (GPS), General Packet Radio Service (GPRS), Global System for Mobile Communication (GSM), and Code Division Multiple Access (CDMA).

The controller 6 is configured in use to receive data from the communication interface 4 and send data to the communication interface 4. Further, the controller 6 is configured in use to control the operation of the communication interface 6, for example, by controlling when and what data is transmitted or received by the communication interface 4. Also, the controller 6 may instruct by which communication standard or protocol the communication interface 4 communicates. In an embodiment, the controller 6 may comprise at least one processor and at least one memory having computer program code stored thereon. In use, the at least one memory and the computer program code may be configured to, with the at least one processor, cause the mobile computing device 2 to perform various functions. Also, as mentioned above, the controller 4 may cause the communication interface 4 to perform various functions. In an embodiment, the at least one memory may include a Random Access Memory (RAM) and/or a Read Only Memory (ROM). In an embodiment, the controller 56 may include a battery for powering the various hardware elements of the mobile computing device 2.

In an embodiment, the controller 6 also includes an I/O interface to the communication interface 4. This and other components of the controller 6 may communicate via an interconnected bus and in a manner known to the person skilled in the relevant art.

In an embodiment, the computer program code may be supplied to a user of the mobile computing device 2 encoded on a computer-readable storage medium such as a flash memory module or memory card/stick and read utilizing a corresponding memory reader-writer (not shown) of the mobile computing device 2. Alternatively, the computer program code may be incorporated in the at least one memory during manufacture or downloaded to the at least one memory via the communication interface 4 during use. The computer program code may be read and controlled in its execution by the at least one processor. Intermediate storage of program data may be accomplished using the at least one memory, for example, RAM.

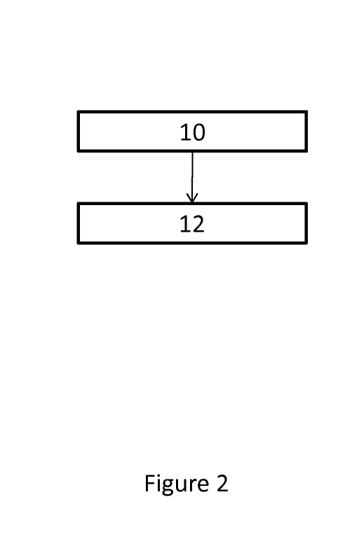

FIG. 2 represents an operation of the mobile computing device 2 in the form of a flow diagram. The operation of FIG. 2 relates to performing a financial transaction with an external device. The external device may be a remote computing device with which the mobile computing device 2 is capable of communicating.

At 10, the mobile computing device 2 receives account information from a server device. The server device may be a remote computing device with which the mobile computing device 2 is capable of communicating. In an embodiment, the server device is part of a financial institution, such as a bank, which holds (e.g. manages and administers) the account referred to in the account information.

In an embodiment, the account information comprises data which specifies an account to be used in performing the financial transaction. The account may be an account of the user of the mobile computing device 2. The account information may also provide authentication information required by a third party to take funds out of the account and/or to put funds into the account. In this way, the mobile computing device 2 may be incapable of performing a transaction without first receiving the authorization information from the server device. It is to be understood that the account information is received at the communication interface 4 and the account information is then passed to the controller 6.

At 12, the mobile computing device 2 transmits payment information to the external device. The payment information includes the account information. Therefore, the payment information also specifies the account to be used in performing the financial transaction. In an embodiment, the payment information may include a Virtual Card Number (VCN) for use in performing the financial transaction. The VCN may have been provided in the account information by the server device.

In an embodiment, the payment information may be generated by the controller 6 based on the account information provided by the communication interface 4. The generated payment information may then be provided by the controller 6 to the communication interface 4, and the controller 6 may then instruct the communication interface 4 to transmit the generated payment information to the external device. Generating the payment information may include adding permission information to indicate that the mobile computing device 2 is authorized to perform transactions using the account information.

It is to be understood that authorization information may be required by an external device (such as a merchant's device) to take funds from the account. On the other hand, permission information may be required to validate that the authorization information has come from a source which is permitted to provide it. Accordingly, the external device may then present the authentication information and the permission information to a server device (such as a financial institution). The authentication information proves to the server device that the external device is authorized to take money from the account, and the permission information proves that the external device has been authorized to take money out of the account by someone (i.e. the mobile computing device 2) which is permitted to provide such authorization. In this way, security may be enhanced.

In another embodiment, the payment information including the account information may be received at the communication interface 4 from the server device. Accordingly, the controller 6 may not generate the payment information and, instead, may simply forward the received payment information to the server device using the communication interface 4. In this embodiment, the payment information may still include permission information to indicate that the mobile computing device 2 is authorized to perform transactions using the account information.

In an embodiment, the controller 6 may perform some authentication of the information received from the server device, for example, to verify that the information is from an authorized source. In this way, it is possible for the mobile computing device 2 to detect when a malicious third party is attempting to gain unauthorized access to an account by pretending to be a server device.

In an embodiment, the payment information may authorize the external device to take payment from the account to perform the transaction. For example, the external device may be a merchant device, such as, an electronic point of sale system in a shop. In this embodiment, the transaction may be an exchange of money for goods and/or services. Accordingly, the merchant may provide the goods and/or services once the transaction is performed. Performance of the transaction may be achieved once the external device has received the payment information which authorizes the merchant to take payment for the goods and/or services from the account corresponding to the account information contained within the payment information. In an embodiment, the transaction may be performed once the payment has been received into the merchant's account.

In an embodiment, the communication interface 4 may communicate with the external device via NFC, such as, via the MasterCard™ PayPass™ protocol or via another contactless payment protocol as would be known to a person skilled in the art. In this way, the mobile computing device 2 may be used to perform a Card Present transaction. In another embodiment, the communication interface 4 may communicate with the external device via Wi-Fi and, perhaps, one or more computer networks (such as the internet). In this way, the mobile computing device 2 may be used to perform a Card Not Present transaction.

In an embodiment, the payment information authorizes the external device to authorize a further external device to take payment from the account to perform the transaction. For example, the external device may be a secondary computing device of the user of the mobile computing device 2. The secondary computing device may be a laptop, a Personal Digital Assistant (PDA), a mobile telephone, a tablet computer, a desktop computer or the like. The mobile computing device 2 may be configured to pair (or link) with the external device such that the two devices may communicate with each other. In an embodiment, the mobile computing device 2 and the external device may communicate with each other via Bluetooth™ or Wi-Fi. For example, the payment information may authorize the external device to perform a transaction with a further external device, such as, a merchant device. The external device may perform the transaction with the further external device as described above. In this way, the mobile computing device 2 may be used by the external device to perform a transaction between the external device and the further external device.

In an embodiment, the payment information authorizes the external device to add payment to the account to perform the transaction. For example, the user of the mobile computing device 2 may be a merchant and the user of the external device may be a customer. As before, the transaction may be an exchange of money for goods and/or services. Accordingly, the merchant may provide the goods and/or services once the transaction is performed. Performance of the transaction may be achieved once the external device has received the payment information which authorizes the external device to add payment for the goods and/or services into the account corresponding to the account information contained within the payment information. Once payment has been received, the user of the mobile computing device 2 may provide the user of the external device with the goods and/or services. As before, the communication interface 4 may be used by the controller 6 to perform a Card Present or a Card Not Present transaction.

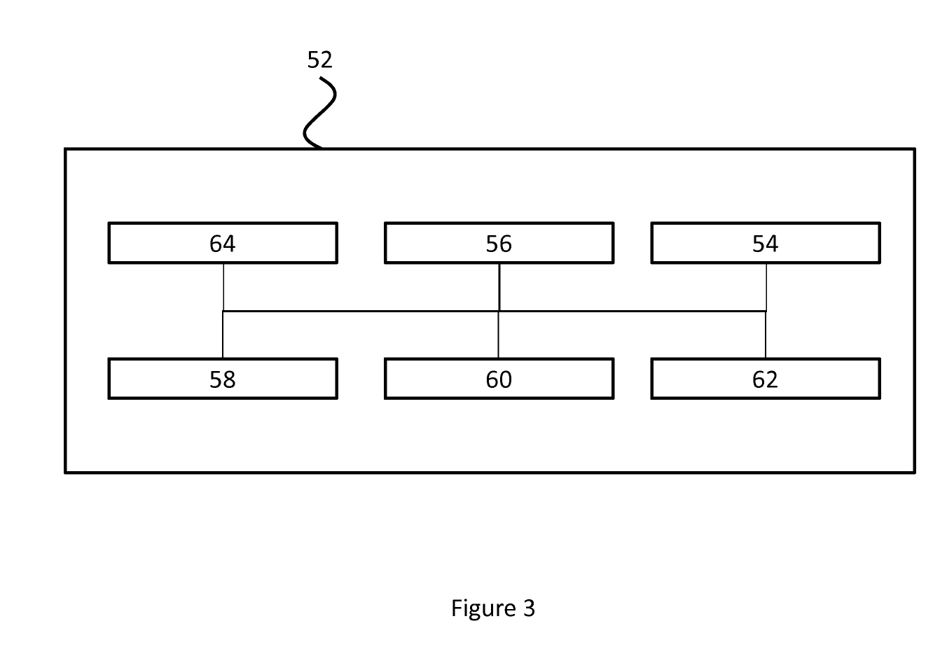

FIG. 3 shows a mobile computing device 52 in accordance with an embodiment. As before, the mobile computing device 52 comprises a communication interface 54 and a controller 56 which are cable of performing the operations of the above-described communication interface 4 and controller 6, respectively.

In an embodiment, the mobile computing device 52 may further comprise one or more of the following elements: an input interface 58, a locking interface 60, a location detector 62, and a display screen 64.

In an embodiment, the input interface 58 is configured in use to receive an input from a user of the mobile computing device 52. For example, the input interface 58 may comprise one or more hardware keys or buttons which may be activated by a user in order to provide the input. Additionally or alternatively, the input interface 58 may comprise a touch screen, wherein the user can touch part of the screen in order to provide the input.

In an embodiment, the controller 56 is configured in use to cause the communication interface 54 to transmit a request for account information to the server device in dependence on the input. It is to be understood that this operation may be performed before the operation described in block 10 of FIG. 2. Accordingly, the user may initiate the performing of a transaction by requesting account information from the server device. The input may specify the account to be used in performing the transaction and this account may also be specified in the request for account information. Accordingly, the account information received by the communication interface 54 may relate to the account specified by the user. Additionally, as described above, the received account information may also include authentication information required by third parties to add and remove funds from the account. In an embodiment, the input interface 58 may be used by the user to specify one of a plurality of different accounts to be used to perform the transaction. In this way, the mobile computing device 52 may function like a wallet rather than just a single payment card.

In an embodiment, the controller 56 is configured in use to cause the communication interface 54 to transmit the payment information to the external device in dependence on the input. It is to be understood that this operation may be performed in-between the operations described in blocks 10 and 12 of FIG. 2. In this way, the performing of the transaction may be performed in dependence on the user's input. Thus, the user may be in control of when the transaction is performed.

In an embodiment, the locking interface 60 may be configured in use to receive an unlock instruction from the user. The controller 56 may be configured in use to disable the mobile computing device 52 based on a comparison between the unlock instruction and a valid unlock key. For example, if the comparison shows that the unlock instruction and the valid unlock key do not (substantially) match the mobile computing device 52 may be disabled. Accordingly, control of the mobile computing device 52 by the user may be made dependent on the user providing an unlock instruction which matches or contains the unlock key. An advantage of this operation is that an unauthorized third party cannot use the mobile computing device 52 to perform a transaction because the unauthorized third party will not know the unlock key and so their unlock instruction will not match or contain the unlock key.

In an embodiment, after a preset time period, the locking interface 60 may cause the mobile computing device 52 to enter a locked mode. Whilst in the locked mode, it may be the case that inputs to the locking interface 60 are received, but some or all other functions of the mobile computing device 52 may be suspended. It may only be possible to cancel the locked mode and return to normal operation after performing a successful unlock operation, as described above. In this way, if the mobile computing device 52 is left unused for the preset time period, it may need to be unlocked before it can be used again.

In an embodiment, the locking interface 60 may be incorporated into the same hardware element as the input interface 58. In an alternative embodiment, both the locking interface 60 and the input interface 58 may be separate hardware elements. In an embodiment, the locking interface 60 may be provided by a touch screen. The locking interface 60 and the input interface 58 may use the same touch screen. The unlock instruction may be a sequence of strokes on the touch screen, wherein each stroke represents a path on the touch screen and/or a number. Additionally or alternatively, the unlock instruction may be a sequence of key presses. Accordingly, the unlock key may represent a preset sequence of strokes or key presses.

In an embodiment, the communication interface 54 is configured in use to receive the valid unlock key from the server device and to provide the received unlock key to the controller 56 to perform the comparison. Advantageously, this arrangement prevents a third party from hacking into the mobile computing device 52 to obtain the unlock key and maliciously gain access to the user's account information and payment information. The unlock key may be encrypted when transmitted from the server device to the mobile computing device 52 and then decrypted by the controller 56 to extract the unlock key. Advantageously, this arrangement prevents a third party from intercepting the unlock key during transmission from the server device to the mobile computing device 52.

In an embodiment, the locking interface may comprise a biometric sensor (or detector) for sensing (or detecting) a value of a biometric identifier of the user. In an embodiment, the biometric identifier may be one or more of the following non-limiting examples: fingerprint, face pattern, DNA, palm print, hand geometry, iris, retina, voice and odor/scent. In this embodiment, the unlock key may include a valid value of the biometric identifier, i.e. the authentic user's value. For example, if the biometric identifier is a fingerprint, a representation of the authentic user's fingerprint may be included in the unlock key. The detected value of the biometric identifier and the valid value of the biometric identifier may be in the form of a numeric value which uniquely identifies a particular fingerprint. In an embodiment, the detected value and the valid value must match or substantially match to activate the mobile computing device 52. In an embodiment, one or more biometric identifiers may be examined. In an embodiment, one or more of the examinations may need to succeed before the mobile computing device 52 is activated, i.e. not disabled. In an embodiment, activating (i.e. enabling) or deactivating (i.e. disabling) of the mobile computing device 52 may include activating or deactivating the controller 56, the input interface 58 and/or the communication interface 54.

In an embodiment, the controller 56 may include biometric recognition software for use with a touch screen (for example, the input interface 58), such that the user may present a fingerprint to the touch screen to unlock the mobile computing device 52.

In an embodiment, the controller 56 may be configured in use to disable the mobile computing device 52 in response to receiving a locking instruction from the server device. Specifically, the locking instruction may be received at the communication interface 54 and passed to the controller 56. On receiving the locking instruction, the controller 56 may disable the mobile computing device 52. For example, disabling may include deactivating the input interface 58, or powering down the mobile computing device 52. In a further embodiment, disabling may include running a preset operation, such as, a formatting operation in order to erase all data from the mobile computing device 52. It is to be understood that the operation resulting from receiving a locking instruction from the server device may be different to the locking mode mentioned above. For example, the state of lockdown may be more severe when a locking instruction is received from the server device compared to when the mobile computing device is simply left unused for a preset time period.

In an embodiment, the location detector 62 may be configured in use to detect a location of the mobile computing device 52. The location detector 62 may comprise a GPS antenna and associated circuitry which allows the mobile computing device 52 to determine its location based on one or more positioning satellites. Alternatively, the location detector 62 may include part of the communication interface 54. For example, the location detector 62 may include a Wi-Fi antenna and associated circuitry and the location detector 62 may be configured in use to determine its location based on information received by the communication interface 54 from one or more Wi-Fi routers. In an embodiment, the controller 56 may be configured in use to cause the communication interface 56 to transmit the location of the mobile computing device 52 to the server device. For example, this operation could be performed periodically and/or in response to a specific request from the server device 52. In this way, it may be possible for the server device and the associated financial institution to keep track of the location of the mobile computing device 52. Accordingly, if the device is stolen or lost, the server device may be consulted to find the mobile computing device 52.

In an embodiment, the controller 56 is configured in use to include the location of the mobile computing device 52 in the payment information. For example, the payment information may additionally include details of a location based offer which the user of the mobile computing device 52 wishes to use in order to perform the transaction. For example, using the offer may entitle the user to a discount and so may reduce the payment required to perform the transaction. In other words, the offer may form part of the payment information with the account information. The offer information may be included with, or as part of, the account information sent from the server device. However, use of the offer may be conditional on the mobile computing device 52 being at a particular location or within a particular area. For example, the payment information sent by the controller 56 to the external device may include (i) offer information specifying a discount off the payment due, (ii) location information for validating the offer information as mentioned above, and (iii) account information specifying the account from which the payment is to be taken. If the location information fulfills the offer requirements, the discount is applied and the discounted payment is taken. On the other hand, if the location information does not meet the offer requirements, the discount is not applied and the payment taken may be the full amount. In this way, the mobile computing device 52 may be used to redeem a location-based offer.

In an embodiment, the display screen 64 may be configured in use to display information based on instructions from the controller 56. For example, the controller 56 may cause the display screen 64 to display information based on data received at the communication interface 54. Also, the controller 56 may cause the display screen 64 to display information based on data stored on a memory of the mobile computing device 52. In an embodiment, the account information received from the server device may include account information for display, such as, for example, an account balance, an amount of credit available, one or more messages for the account holder (i.e. the user of the mobile computing device 52). The display screen 64 may be used to display some or all of this information to the user. Additionally, if the account information includes offer information, the controller 56 may be configured in use to display this offer information on the display screen 64, for example, to notify the user of what discount is available or to notify the user of what conditions must be satisfied in order to redeem the offer. In an embodiment, the display screen 64 may be a touch screen which provides the input interface 58 and/or the locking interface 60. Furthermore, the mobile computing device 52 may separately receive data from the server device regarding location-based offers and the mobile computing device 52 may be configured in use to display information about these offers, for example, when the mobile computing device 52 is at the associated offer location or in the associated offer area. Additionally, the mobile computing device 52 may provide a browser functionality such that the display screen 64 in conjunction with the input interface 58 may be used to scroll through a list of offers.

In an embodiment, the display screen 64 may be used to display a special code in order to redeem an offer, such as, a location-based offer. For example, the code may be a barcode, a numeric code or a Quick Response (QR) code.

In an embodiment, the controller 56 also includes an I/O interface to the display screen 64, an I/O interface to the input interface 58, an I/O interface to the locking interface 60, and an I/O interface to the location detector 62. These and other components of the controller 56 may communicate via an interconnected bus and in a manner known to the person skilled in the relevant art.

In an embodiment, the mobile computing device 52 may comprise a case in which all hardware elements are housed. The case may have the following dimensions: about 0.085 m wide by about 0.054 m high by about 0.007 m deep. In an embodiment, a substantial portion of either the front or back of the case may be the display screen 64, for example, a touch screen. In an embodiment, the case may be metallic or at least partly metallic. Further, one or more parts of the case may be made of plastic.

In an embodiment, the mobile computing device 52 may be preloaded with information on the user's accounts. It is to be understood that this information may simply identify the accounts without providing any information which may be used to perform a transaction. As mentioned above, information which may be used to perform a transaction may be obtained from the server device. In an embodiment, this information may only be obtained from the server device. In an embodiment, the preloaded information may be added to the mobile computing device 52 during manufacture. Additionally or alternatively, the preloaded information may be downloaded to the mobile computing device 52, for example, from the server device. Additionally or alternatively, the preloaded information may be input by the user using the input interface 58. The mobile computing device 52 may include preloaded information on one or more of the user's accounts.

In an embodiment, the mobile computing device 52 may include one or more MasterCard™ PayPass™ microchips for associating with one or more of the user's accounts. These microchips may be controlled by the controller 56.

In an embodiment, the mobile computing device 52 may be capable of receiving from the server device other data in addition to account information. For example, the mobile computing device 52 may be capable of downloading one or more software applications from the server device. For example, the software applications may be related to performing transactions. In an embodiment, the software applications may manage or store offers or rewards relating to the user's accounts. These offers and rewards may be redeemable when performing transactions. In an embodiment, the software applications may provide other banking or payment related services, such as, applying for credit on an account or performing a balance transfer between two different accounts. In an embodiment, the software application may be downloaded from cloud storage, for example, via a Wi-Fi connection and the internet. In an embodiment, offers and/or rewards may be downloaded from the server device. In an embodiment, offers and/or rewards may be downloaded from one or more different external devices, such as, an external merchant device. For example, the mobile computing device 52 may download an offer from a merchant device, wherein the offer encourages the user to purchase goods and/or services from the merchant or an affiliated merchant.

In an embodiment, the mobile computing device 52 may be operable to pair with an external device such that the two devices may communicate with each other. For example, the mobile computing device and the external device may communicate with each other via Bluetooth™ or Wi-Fi. The external device may be a computer, a PDA, a cellphone or the like. When paired together, the mobile computing device 52 may send data to the external device. For example, the data may include payment information for performing a transaction, as described above. Additionally or alternatively, the data may include information for reproduction (e.g. display, printing) by the external device. For example, the mobile computing device 52 may send information about an account (e.g. an account balance or a credit limit) for display on the external device. In this way, pairing the mobile computing device 52 with the external device may be performed to cause the external device to display information stored on the mobile computing device 52.

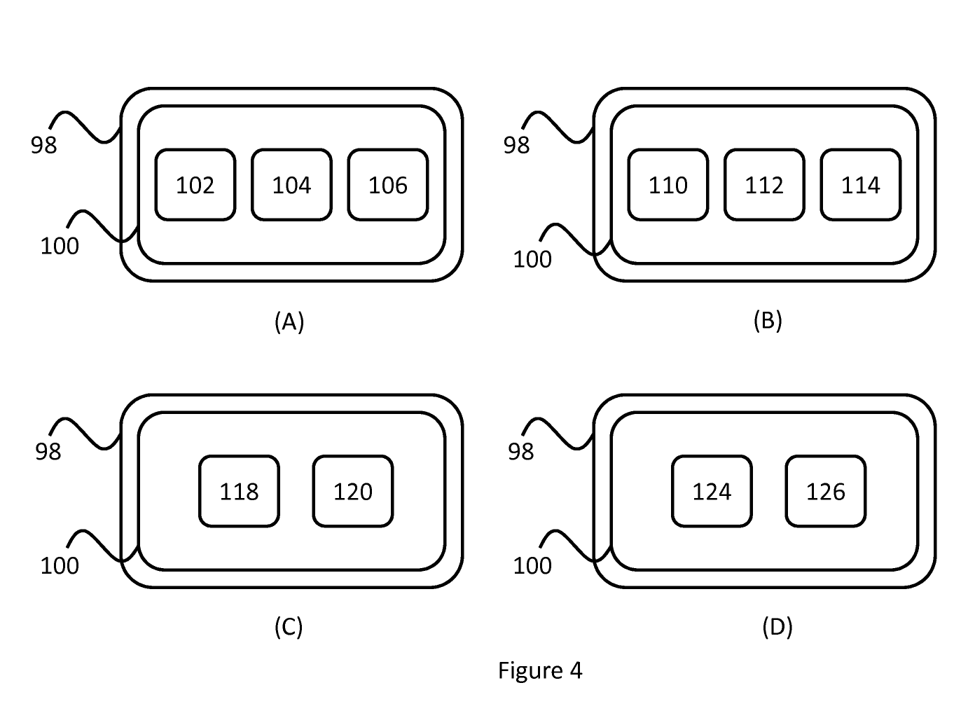

FIGS. 4a to 4b illustrate a graphical user interface for controlling a mobile computing device 98 to perform a transaction, in accordance with an embodiment. The mobile computing device 98 may have all of the above-described elements of the mobile computing device 52. In particular, the mobile computing device 98 includes a touch screen 100 which covers a substantial portion of the front face, as shown in FIGS. 4a to 4d. The touch screen 100 provides at least the input interface and the display screen of the mobile computing device 98.

In FIG. 4a, three icons 102, 104 and 106 are presented on the touch screen 100. The icon 102 represents ‘ACCOUNTS’, the icon 104 represents ‘OFFERS’ and the icon 106 represents ‘REWARDS’. FIG. 4a may be seen as a main menu screen. If the user presses the screen at icon 102, the graphical user interface of FIG. 4b is presented on the touch screen 100.

In FIG. 4b, three accounts are presented on the display screen, as indicated by icons 110, 112 and 114. Accordingly, the mobile computing device 98 is associated with three of the user's accounts. In an example, each account may be represented by a picture of a banking card relating to that account. In an embodiment, below each icon 110, 112, 114, some information may be presented which relates to the account represented by that icon. For example, a credit limit and/or the available funds in the account may be shown below each icon. In some other embodiments, different information may be shown. In any case, this information may be provided based on account information received from the server device. The icons 110, 112, 114 may be information which is preloaded on the mobile computing device 98. If the user presses the screen at, for example, icon 110, the graphical user interface of FIG. 4c is presented on the touch screen 100.

In FIG. 4c, two icons 118 and 120 are presented on the display screen. The icon 118 permits the user to activate an NFC capability of the communication interface of the mobile computing device 98. Once the NFC capability is activated, payment information may be transmitted to an external device to perform a transaction. The icon 120 permits the user to cancel the selection of the icon 110 and return to the screen of FIG. 4b. If the user presses the screen at icon 118, the graphical user interface of FIG. 4d is presented on the touch screen 100.

In FIG. 4d, two icons 124 and 126 are presented on the touch screen 100. The icon 124 instructs the external device (e.g. a merchant device) to print the transaction receipt. For example, this option may be used during a Card Present transaction. The icon 126 instructs the external device (e.g. a merchant device) to send the transaction receipt electronically, for example, by email or via short message service (SMS). For example, this option may be used during a Card Not Present transaction.

According to the above operation, the mobile computing device 98 can be used to perform a transaction.

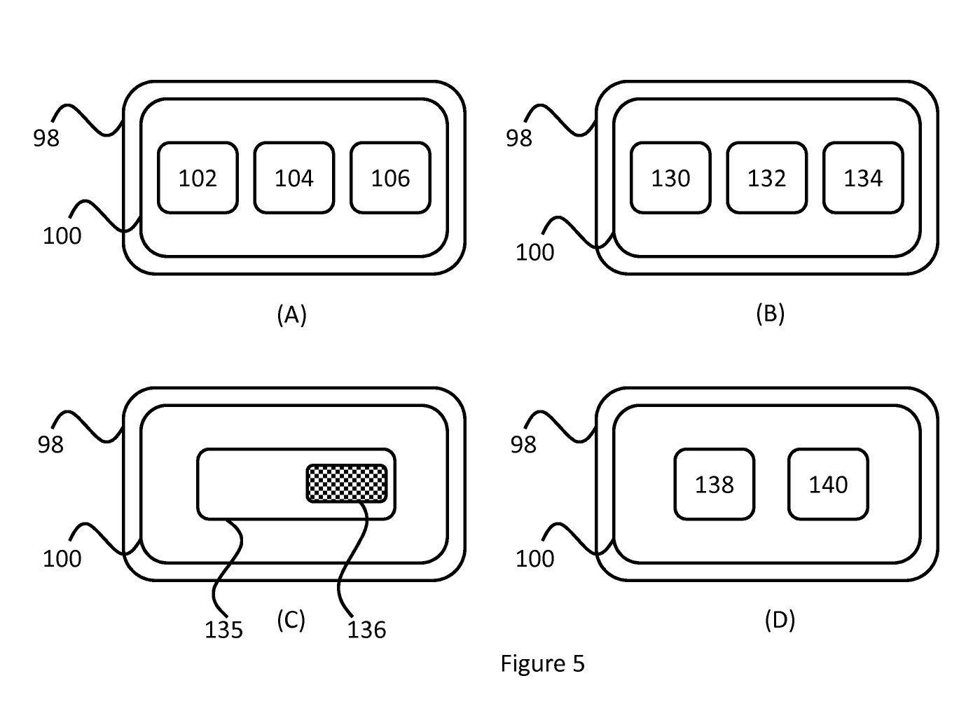

FIGS. 5a to 5b illustrate a graphical user interface for controlling the mobile computing device 98 to use an offer associated with a user account, in accordance with an embodiment.

FIG. 5a is analogous to FIG. 4a mentioned above, i.e. it is the main menu screen. This time, however, the user selects the icon 104, i.e. OFFERS. This action causes the graphical user interface of FIG. 5b to be displayed on the touch screen 100.

In FIG. 5b, three options are presented on the touch screen 100 represented by icons 130, 132 and 134. The icon 130 causes the display screen to present offers relating to dining. The icon 132 causes the display screen to present offers relating to travel. The icon 134 causes the display screen to present offers relating to shopping. In different embodiments, a different group of categories could be represented. Also, a different number of categories could be shown. In an embodiment, the icons may include a picture of the category to which it relates. For example, the icon 130 may show a picture of a knife and fork, the icon 132 may show a picture of an airplane, and the icon 134 may show a picture of a shopping cart.

In FIG. 5c, an offer 135 relating to shopping is presented. In particular, the graphical user interface includes a code 136 to be used to redeem the offer 135. In an embodiment, this code 136 is a QR code. However, in some other embodiments, the code 136 may be a numeric code or a barcode. In any case, the user may touch the touch screen 100 to select the offer 135 or may scroll to another offer, for example, by swiping the touch screen 100. Once an offer has been selected, the graphical user interface of FIG. 5d is presented on the touch screen 100.

In FIG. 5d, two icons 138 and 140 are presented on the touch screen 100. The icon 138 instructs an external device (e.g. a merchant device) to scan the code 136 on-screen so that the offer 135 can be redeemed. In an embodiment, the code 136 is displayed after the icon 138 is pressed. The icon 140 causes the mobile computing device 100 to send the code 136 to the external device so that the offer 135 can be redeemed. Once the external device has received the code 136, the code 136 can be validated in order to perform the transaction. Accordingly, the payment information sent to the external device includes the offer code 136. Also, the account information obtained from the server device includes the account linked offer 135 and the associated offer code 136.

According to the above operation, the mobile computing device 98 can be used to perform a transaction by redeeming an offer.

It is to be understood that in some embodiments, additional information may be presented on each graphical user interface screen. For example, the top right corner of each screen may indicate a level of charge in a battery of the mobile computing device 98, a signal-strength of a communication path between the communication interface and an external device, a time and/or a date.

An advantage of some of the above-described embodiments is that the mobile computing device cannot be used without first obtaining account information from the server device, wherein the account information contains authentication information. In this way, the mobile computing device cannot be used to perform transactions without first obtaining authentication information from the server device. It is also an advantage of some of the above-described embodiments that to obtain the authentication information, an input must be provided in order to cause the mobile computing device to send a request for account information to the server device. Furthermore, in some embodiments, the input interface is locked until a valid unlock instruction is provided. Accordingly, it is an advantage of some embodiments that security is provided because the mobile computing device does not store the account information and only an authorized user can activate the mobile computing device to obtain the account information from the server device. Stated differently, an unauthorized user cannot unlock the mobile computing device and so cannot then obtain the user's account information. In an embodiment, the mobile computing device does not store any payment related information to reduce the security risk associated with losing the device.

An advantage of some embodiments is that the mobile computing device can be a specially designed hardware unit capable of performing only the above-described operations, i.e. only operations relating to performing transactions. Accordingly, a user is not confused by a multitude of other operations which may be performed using the mobile computing device. In an embodiment, the mobile computing device is only suitable for use in performing transactions.

An advantage of some embodiments is that the user can retrieve account information relating to one of a plurality of accounts. Therefore, the mobile computing device may be used as any one of a plurality of different payment cards. In other words, the mobile computing device may provide a functionality which more closely resembles a wallet than a single payment card. Furthermore, the dimensions of the mobile computing device are similar to those of a standard credit card or payment card. Accordingly, the mobile computing device may be conveniently carried around by the user, for example, in their pocket, purse, wallet or bag.

An advantage of some embodiments is that the mobile computing device may provide many different options with which a transaction may be performed. For example, a card present transaction may be performed by utilizing an NFC capability of the communication interface. Additionally or alternatively, a card not present transaction may be performed by utilizing a Bluetooth™ or Wi-Fi capability of the communication interface.

An advantage of some embodiments is that security is enhanced by virtue of the fact that the mobile computing device can be deactivated in response to receiving a locking instruction from the server device. Also, the mobile computing device can be tracked in the event that it is lost or stolen. Such features are of particular importance since the mobile computing device is configured for use in performing transactions and so can be used to take funds from a user's account. The security measures therefore act to prevent third parties gaining malicious access to the user's account information to steal money.

An advantage of some embodiments is that the mobile computing device can be used to communicate with banking institutions, merchants and customers. Accordingly, the mobile computing device can support a suite of different electronic payment applications. In an embodiment, the mobile computing device may be a payment device, i.e. a mobile computing payment device.

It will be appreciated by a person skilled in the art that numerous variations and/or modifications may be made to the present invention as shown in the specific embodiments without departing from the scope of the appended claims as broadly described. The present embodiments are, therefore, to be considered in all respects to be illustrative and not restrictive.

What is claimed is:

1. A mobile computing device comprising:
a communication interface configured in use to wirelessly transmit and receive data; and
a controller configured in use to cause the communication interface to transmit payment information to an external device to perform a transaction, the payment information including account information received by the communication interface from a server device, the account information specifying an account for use in performing the transaction.

2. The mobile computing device of claim 1, wherein the payment information authorizes the external device to take payment from the account to perform the transaction.

3. The mobile computing device of claim 1, wherein the payment information authorizes the external device to authorize a further external device to take payment from the account to perform the transaction.

4. The mobile computing device of claim 1, wherein the payment information authorizes the external device to add payment to the account to perform the transaction.

5. The mobile computing device of claim 1, further comprising an input interface configured in use to receive an input from a user of the mobile computing device.

6. The mobile computing device of claim 5, wherein the controller is configured in use to cause the communication interface to transmit a request for the account information to the server device in dependence on the input.

7. The mobile computing device of claim 5, wherein the controller is configured in use to cause the communication interface to transmit the payment information to the external device in dependence on the input.

8. The mobile computing device of claim 1, further comprising a locking interface configured in use to receive an unlock instruction from the user, wherein the controller is configured in use to disable the mobile computing device based on a comparison between the unlock instruction and a valid unlock key.

9. The mobile computing device of claim 8, wherein the communication interface is configured in use to receive the valid unlock key from the server device and to provide the valid unlock key to the controller to perform the comparison.

10. The mobile computing device of claim 8, wherein the locking interface comprises a biometric sensor for sensing a value of a biometric identifier of the user and the unlock instruction includes the value of the biometric identifier, and wherein the valid unlock key includes a valid value of the biometric identifier.

11. The mobile computing device of claim 1, wherein the controller is configured in use to disable the mobile computing device in response to receiving a locking instruction from the server device.

12. The mobile computing device of claim 1, further comprising a location detector for detecting a location of the mobile computer device, wherein the controller is configured in use to cause the communication interface to transmit the location of the mobile computing device to the server device.

13. The mobile computing device of claim 12, wherein the controller is configured in use to include the location of the mobile computing device in the payment information.

14. The mobile computing device of claim 1, further comprising a display screen, wherein the controller is configured in use to cause the display screen to display information based on data received by the communication interface.

15. The mobile computing device of claim 1, wherein the mobile computing device is housed within a case having the following dimensions: 0.085 m×0.054 m×0.007 m.

16. The mobile computing device of claim 1, wherein the mobile computing device is a payment device.

17. A method for performing a transaction, the method comprising:
receiving account information from a server device at a mobile computing device, the account information specifying an account for use in performing a transaction; and
transmitting payment information from the mobile computing device to an external device to perform the transaction, the payment information including the account information.

18. A computer-readable storage medium having stored thereon computer program code which when executed by a computer causes the computer to execute the method of claim 17.
